(19) United States
(12) Patent Application Publication
(10) Pub. No.: US 2021/0165086 A1
(43) Pub. Date: Jun. 3, 2021

(54) SIGNAL PROBING SYSTEM, SIGNAL PROCESSING METHOD AND RELATED PROBING MODULE

(71) Applicant: QISDA CORPORATION, Taoyuan City (TW)

(72) Inventors: Ya-Wen Chen, Hsinchu City (TW); Fang-Bin Liu, Hsinchu City (TW)

(21) Appl. No.: 16/835,158

(22) Filed: Mar. 30, 2020

(30) Foreign Application Priority Data
Nov. 28, 2019 (CN) 201911194765.2

(51) Int. Cl. G01S 7/52; G01S 15/89; G01S 15/96

(52) U.S. Cl. CPC G01S 7/52003; G01S 15/96; G01S 15/89

(57) ABSTRACT

A signal probing system includes: a probing module, including a transmitting device, a first probing device and a second probing device, wherein the transmitting device is configured to transmit a first signal, the first probing device is coupled to the second probing device, and the first probing device and the second probing device are respectively configured to receive a high frequency reflective signal and a low frequency reflective signal corresponding to the first signal; and a processing module coupled to the probing module, the processing module being configured to process the high frequency reflective signal and the low frequency reflective signal into image signals.

### BACKGROUND OF THE INVENTION

### 1. Field of the Invention

The present invention relates to a signal probing system, a signal processing method and a related probing module, and more particularly, to a signal probing system, a signal processing method and a related probing module capable which are not limited to probing an image in a single direction.

### 2. Description of the Prior Art

Conventional sonar probing techniques based on underwater acoustics utilize sound waves underwater to perform probing, positioning and communication with respect to targets. The sound waves penetrate the water to directly detect objects underwater and the surrounding environment, and present the results in the form of images. Sonar probing techniques are often used by ships for probing groups of fish in the water. Two different kinds of probing techniques are often used. The first technique probes the bottom of the water to determine a depth of the water and the fish species therein; this technique requires images with higher resolution so that the various species can be recognized. The second technique performs probing in front of the ship to determine a distribution of a group of fish at a further distance. The conventional sonar probing technique therefore requires two different sonar probing devices to satisfy the above mentioned requirements, i.e. different probes must be switched in to satisfy the respective goals. Therefore, improvements to the conventional technique are needed.

### SUMMARY OF THE INVENTION

The present invention provides a signal probing system, a signal processing method and a related probing module, which is not limited to probing images in a single direction, to prevent the disadvantages of the conventional technique.

An embodiment of the present invention discloses a signal probing system, comprising: a probing module, comprising a transmitting device, a first probing device and a second probing device, wherein the transmitting device is configured to transmit a first signal, the first probing device is coupled to the second probing device, and the first probing device and the second probing device are respectively configured to receive a high frequency reflective signal and a low frequency reflective signal corresponding to the first signal; and a processing module coupled to the probing module, wherein the processing module is configured to process the high frequency reflective signal and the low frequency reflective signal into image signals.

Another embodiment of the present invention discloses a signal processing method for a signal probing system, the signal probing system comprising a transmitting device, a first probing device, a second probing device and a processing module. The signal processing method comprises: transmitting, from the transmitting device, a first signal; receiving, by the first probing device, a high frequency reflective signal corresponding to the first signal; receiving, by the second probing device, a low frequency reflective signal corresponding to the first signal; switching outputting of the high frequency reflective signal and the low frequency reflective signal to the processing module; and processing, by the processing module, the high frequency reflective signal and the low frequency reflective signal into image signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a signal probing system according to an embodiment of the present invention.

FIG. 2 is a schematic diagram of the signal probing system mounted on a ship hull according to an embodiment of the present invention.

FIG. 3 is a schematic diagram of a signal processing process according to an embodiment of the present invention.

FIG. 4 is a schematic diagram of another signal processing process according to an embodiment of the present invention.

### DETAILED DESCRIPTION

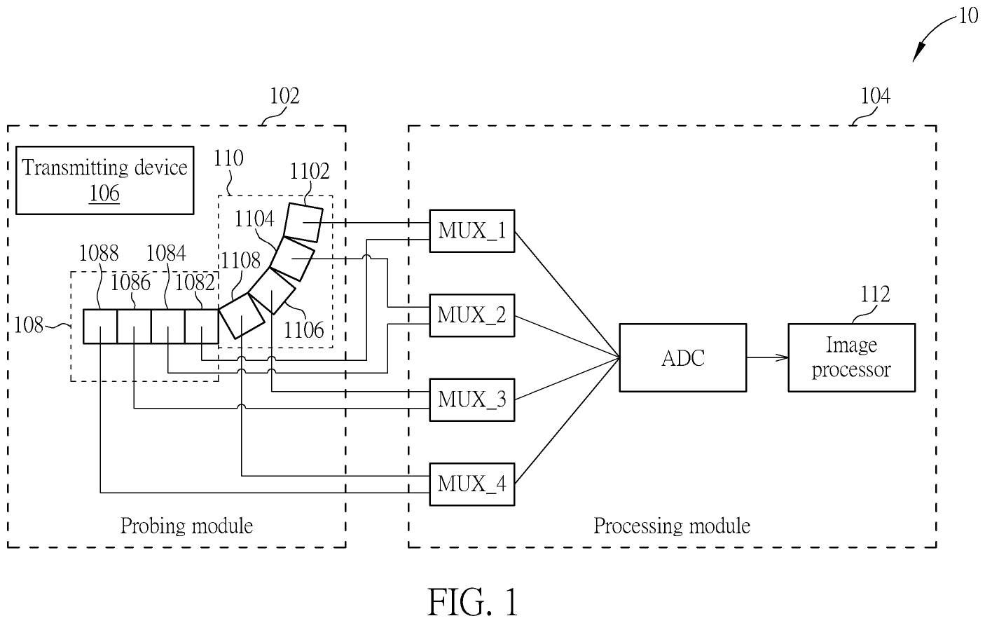

Refer to FIG. 1, which is a schematic diagram of a signal probing system 10 according to an embodiment of the present invention. The signal probing system 10 includes a probing module 102 and a processing module 104. The probing module 102 includes a transmitting device 106, a first probing device 108 and a second probing device 110. The transmitting device 106 is configured to transmit a first signal. The first probing device 108 is coupled to the second probing device 110. The first probing device 108 and the second probing device 110 are configured to respectively receive a high frequency reflective signal and a low frequency reflective signal corresponding to the first signal. In an embodiment, a bandwidth of the first signal covers bandwidths of the high frequency reflective signal and the low frequency reflective signal. The first probing device 108 is a phase array probe; the second probing device 110 is a curved linear array probe. The first probing device 108 and the second probing device 110 may be formed on a piezoelectric material, wherein a thickness of the first probing device 108 and the second probing device 110 are different. The processing module 104 is coupled to the probing module 102 and is configured to process the high frequency reflective signal and the low frequency reflective signal into image signals. Therefore, the signal probing system 10 according to an embodiment of the present invention may perform image probing in different regions with different directions by the first probing device 108 and the second probing device 110 to effectively shorten a probing time and reduce hardware.

In detail, the processing module 104 includes a plurality of multiplexers MUX_1-MUX_4, an analog-to-digital conversion module ADC and an image processor 112. The multiplexers MUX_1-MUX_4 are respectively coupled to the first probing device 108 and the second probing device 110, and are configured to receive and switch outputting of the signal received by the first probing device 108 or the second probing device 110, wherein a first switching amount of the multiplexers MUX_1-MUX_4 to receive the signal from the second probing device 110 is more than a second switching amount of the multiplexers MUX_1-MUX_4 to receive the signal from the first probing device 108. For example, the processing module 104 may switch the multiplexers MUX_1-MUX_4 to receive the signal received by the first probing device 108 or the second probing device 110 at different times, e.g. the processing module 104 may switch the multiplexers MUX_1-MUX_4 to the first probing device 108 at a first time to receive the high frequency reflective signal received by the first probing device 108, and then the processing module 104 may switch the multiplexers MUX_1-MUX_4 to the second probing device 110 at a second time to receive the low frequency reflective signal received by the second probing device 110. The analog-to-digital conversion module ADC is coupled to the multiplexers MUX_1-MUX_4, and is configured to convert the high frequency reflective signal and the low frequency reflective signal outputted from the multiplexers MUX_1-MUX_4 into a high frequency reflective digital signal and a low frequency reflective digital signal. The image processor 112 is configured to respectively process the high frequency reflective digital signal and the low frequency reflective digital signal into a first image and a second image.

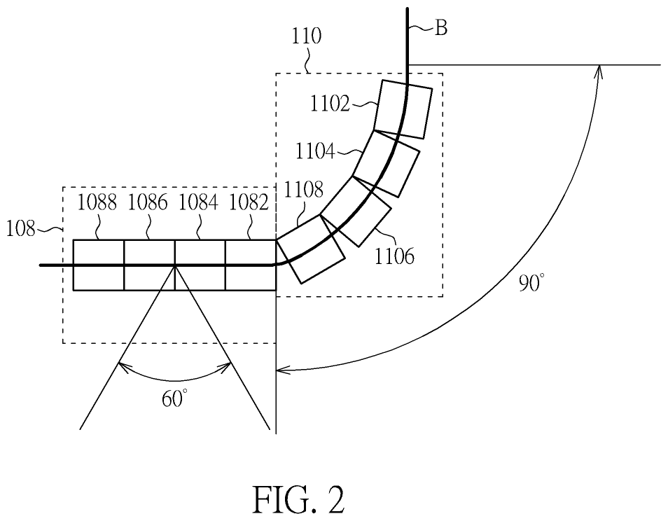

Based on different applications, the probing module 102 of the signal probing system 10 according to an embodiment of the present invention may be mounted on a ship hull, wherein the first probing device 108 may be mounted towards the bottom of the ship hull to receive the high frequency reflective signal, and the second probing device 110 may be mounted towards a front of the ship hull to receive the low frequency reflective signal. Refer to FIG. 2, which is a schematic diagram of the signal probing system 10 mounted on a ship hull B according to an embodiment of the present invention. In an embodiment, the first probing device 108 includes a plurality of first probing elements 1082-1088 and the second probing device 110 includes a plurality of second probing elements 1102-1108, wherein the first probing elements 1082-1088 and the second probing elements 1102-1108 are serially arranged, the first probing elements 1082-1088 are arranged in a straight line, and the second probing elements 1102-1108 are arranged in a curved line. In this example, after the transmitting device 106 of the probing module 102 transmits the first signal, the first probing device 108 may be mounted towards the bottom of the ship hull to receive the high frequency reflective signal, and the second probing device 110 may be mounted towards the front of the ship hull to receive the low frequency reflective signal. In this way, the first probing elements 1082-1088 of the first probing device 108 may receive the high frequency reflective signal reflected by a group of fish at the bottom of a body of water, and use the reflective signal to determine the fish species therein. The second probing elements 1102-1108 of the second probing device 110 may receive the low frequency reflective signal reflected by a group of fish in the body of water in front of the ship hull, to determine a location of the group of fish. In this way, the probing module 102 according to an embodiment of the present invention may convert the high frequency reflective signal and the low frequency reflective signal received by the first probing elements 1082-1088 and the second probing elements 1102-1108 into a high frequency reflective digital signal and a low frequency reflective digital signal, which are then respectively processed by the image processor 112 into the first image and the second image. Notably, the above mentioned ship hull B may be a hull of the ship or a hull of an additional probing module.

Notably, the signal probing system 10 according to an embodiment of the present invention may be formed on one piezoelectric material, which utilizes a manufacturing process to combine the phase array probe and the curved linear array probe to meet different requirements of fish probing, wherein the system is not limited to performing image probing in a single direction without changing probes.

Since the first probing device 108 is the phase array probe with a probing range of about 60 degrees and the second probing device 110 is the curved linear probe with a probing range of about 90 degrees, under the architecture of the probing module 102 according to an embodiment of the present invention, a controller (not depicted in figures) maybe utilized for switching to an appropriate multiplexer. For example, the controller may be configured to control the multiplexers MUX_1, MUX_2 to handle the second probing elements 1102-1108 of the second probing device 110, or control the multiplexers MUX_3, MUX_4 to handle the first probing elements 1082-1088 of the first probing device 108. In another example, the controller may control multiplexers MUX_1 and MUX_4 to handle both the first probing element 1082 and the second probing element 1108, so as to switch the high frequency reflective signal and the low frequency reflective signal received by the first probing device 108 and the second probing device 110.

Since the bandwidth of the first signal transmitted by the transmitting device 106 covers the bandwidths of the high frequency reflective signal and the low frequency reflective signal, the first probing device 108 and the second probing device 110 may receive the high frequency reflective signal and the low frequency reflective signal. When the probing module 102 is applied on a ship hull, the transmitting device 106 transmits the first signal towards the body of water. After the first probing device 108 and the second probing device 110 receive the first signal, the image processor 112 may take different sampling rates for the reflective signals if they have different frequencies or according to a depth of the body of water. In detail, since the image probing is performed in the body of water at a greater distance and at a lower frequency when in front of the ship, and at a closer distance and at a higher frequency when below the ship, after the transmitting device 106 of the probing module 102 transmits the first signal, a reflective time period of the low frequency reflective signal is larger than that of the high frequency reflective signal. In other words, when a sampling frequency of the low frequency reflective signal and the high frequency reflective signal overlaps, the probing module 102 selects to perform sampling for the low frequency reflective signal. Therefore, when the probing module 102 simultaneously receives the high frequency reflective signal and the low frequency reflective signal, the processing module 104 controls the multiplexers MUX_1-MUX_4 to preferentially switch to the second probing device 110 to receive the low frequency reflective signal. A switching amount of the multiplexers MUX_1-MUX_4 to receive the signal from the second probing device 110 is more than that of the multiplexers MUX_1-MUX_4 to receive the signal from the first probing device 108.

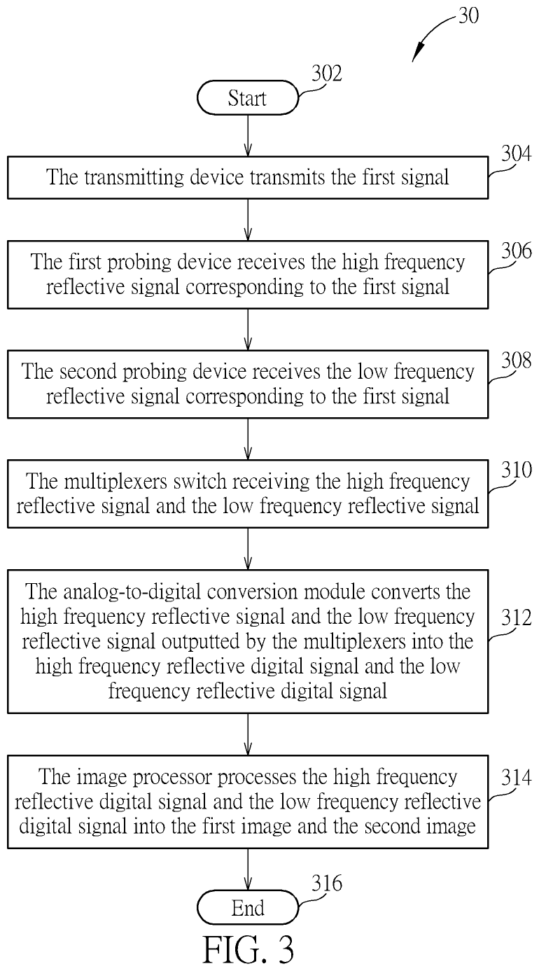

An operation method of the above mentioned signal probing system 10 may be represented by a signal processing process 30, as shown in FIG. 3. The signal processing process 30 includes the following steps:

Step 302: Start.

Step 304: The transmitting device 106 transmits the first signal.

Step 306: The first probing device 108 receives the high frequency reflective signal corresponding to the first signal.

Step 308: The second probing device 110 receives the low frequency reflective signal corresponding to the first signal.

Step 310: The multiplexers MUX_1-MUX_4 switch receiving the high frequency reflective signal and the low frequency reflective signal.

Step 312: The analog-to-digital conversion module ADC converts the high frequency reflective signal and the low frequency reflective signal outputted by the multiplexers MUX_1-MUX_4 into the high frequency reflective digital signal and the low frequency reflective digital signal.

Step 314: The image processor 112 processes the high frequency reflective digital signal and the low frequency reflective digital signal into the first image and the second image.

Step 316: End.

The operation of the signal processing process 30 may further by understood by referring to the above embodiments relating to the signal probing system 10; these details are not narrated herein for brevity.

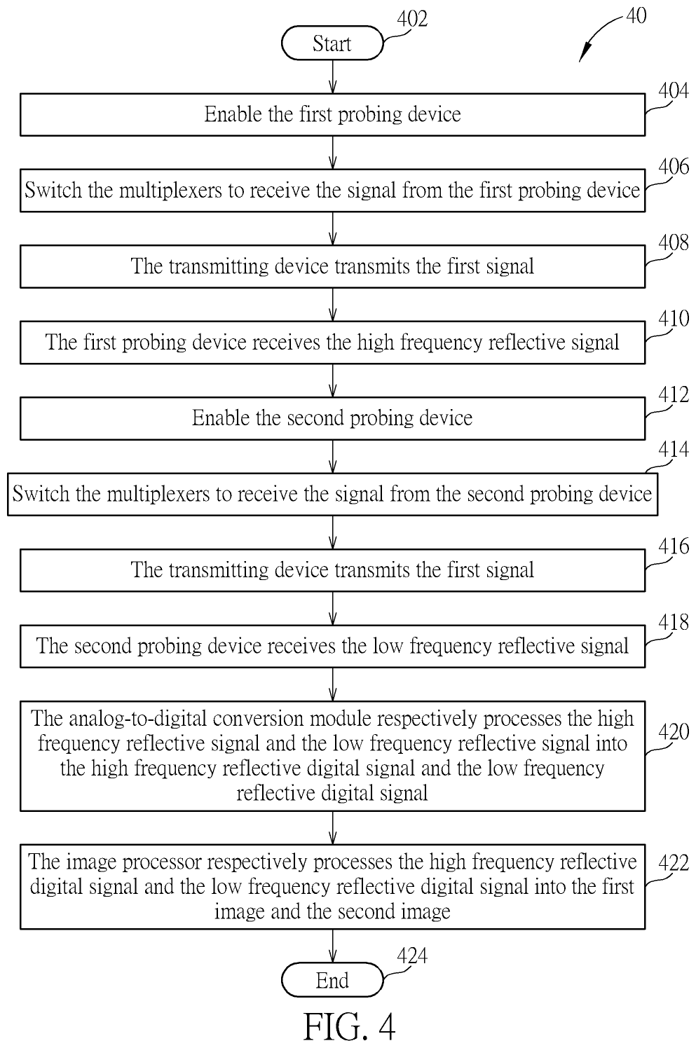

In another embodiment, the signal probing system 10 may control an on/off status of the first probing device 108 and the second probing device 110 of the probing module 102 by the processing module 104 so as to process the reflective signal into the image signals. The embodiment may be represented by a signal processing process 40, as shown in FIG. 4. The signal processing process 40 includes the following steps:

Step 402: Start.

Step 404: Enable the first probing device 108.

Step 406: Switch the multiplexers MUX_1-MUX_4 to receive the signal from the first probing device 108.

Step 408: The transmitting device 106 transmits the first signal.

Step 410: The first probing device 108 receives the high frequency reflective signal.

Step 412: Enable the second probing device 110.

Step 414: Switch the multiplexers MUX_1-MUX_4 to receive the signal from the second probing device 110.

Step 416: The transmitting device 106 transmits the first signal.

Step 418: The second probing device 110 receives the low frequency reflective signal.

Step 420: The analog-to-digital conversion module ADC respectively processes the high frequency reflective signal and the low frequency reflective signal into the high frequency reflective digital signal and the low frequency reflective digital signal.

Step 422: The image processor 112 respectively processes the high frequency reflective digital signal and the low frequency reflective digital signal into the first image and the second image.

Step 424: End.

As compared with the signal processing process 30, the signal processing process 40 first enables the first probing device 108 to receive the high frequency reflective signal, and then enables the second probing device 110 to receive the low frequency reflective signal. In addition, in this embodiment, the processing module 104 respectively processes the high frequency reflective signal and the low frequency reflective signal into the first image and the second image after receiving the high frequency reflective signal and the low frequency reflective signal. In another embodiment, the processing module 104 may first process the received high frequency reflective signal into the first image and then process the received low frequency reflective signal into the second image, i.e. a processing sequence of the high frequency reflective signal or the low frequency reflective signal is not limited by the present invention.

The above mentioned embodiments illustrate that the signal probing system of the present invention may perform image probing for different directions or different regions according to different probing requirements. It should be noted that the signal probing of the present invention may be utilized in medical or other fields according to different requirements. In addition, a quantity of the first probing elements of the first probing device and the second probing elements of the second probing device are not limited to be four; other quantities are all applicable to the present invention and are not limited thereto.

In summary, the present invention provides a signal probing system, a signal processing method and a related probing module, which can perform image probing in different regions with different directions, utilizing different sampling times to shorten a probing time and reduce hardware.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal probing system, comprising:
a probing module, comprising a transmitting device, a first probing device and a second probing device, wherein the transmitting device is configured to transmit a first signal, the first probing device is coupled to the second probing device, and the first probing device and the second probing device are respectively configured to receive a high frequency reflective signal and a low frequency reflective signal corresponding to the first signal; and
a processing module coupled to the probing module, the processing module configured to process the high frequency reflective signal and the low frequency reflective signal into image signals.

2. The signal probing system of claim 1, wherein the processing module comprises:
a plurality of multiplexers, respectively coupled to the first probing device and the second probing device to receive and switch outputting of signals selectively received by the first probing device and the second probing device, wherein a first switching amount of the plurality of multiplexers to receive the signals from the second probing device are more than a second switching amount of the plurality of multiplexers to receive the signals from the first probing device;
an analog-to-digital(ADC) conversion module, coupled to the plurality of multiplexers, configured to convert the high frequency reflective signal and the low frequency reflective signal outputted by the plurality of multiplexers into a high frequency reflective digital signal and a low frequency reflective digital signal, respectively; and
an image processor, configured to respectively process the high frequency reflective digital signal and the low frequency reflective digital signal into a first image and a second image.

3. The signal probing system of claim 2, wherein the first probing device includes a plurality of first probing elements, and the plurality of first probing elements are respectively coupled to the plurality of multiplexers; and the second probing device includes a plurality of second probing elements, and the plurality of second probing elements are respectively coupled to the plurality of multiplexers.

4. The signal probing system of claim 1, wherein the probing module is mounted on a ship hull, the first probing device is mounted towards a bottom of the ship hull to receive the high frequency reflective signal, and the second probing device is mounted towards a front of the ship hull to receive the low frequency reflective signal.

5. The signal probing system of claim 1, wherein the first probing device includes a plurality of first probing elements, the second probing device includes a plurality of probing elements, wherein the plurality of first probing elements and the plurality of second probing elements are arranged in series, the plurality of first probing elements are arranged in a straight line and the plurality of second probing elements are arranged in a curved line.

6. The signal probing system of claim 1, wherein a bandwidth of the first signal covers bandwidths of the high frequency reflective signal and the low frequency reflective signal.

7. The signal probing system of claim 1, wherein the first probing device is a phase array probe and the second probing device is a curved linear array probe.

8. The signal probing system of claim 1, wherein the first probing device and the second probing device are formed on a piezoelectric material, and a thickness of the first probing device and the second probing device are different.

9. A signal processing method fora signal probing system, the signal probing system comprising a transmitting device, a first probing device, a second probing device and a processing module, the signal processing method comprising:
transmitting, from the transmitting device, a first signal;
receiving, by the first probing device, a high frequency reflective signal corresponding to the first signal;
receiving, by the second probing device, a low frequency reflective signal corresponding to the first signal;
switching outputting of the high frequency reflective signal and the low frequency reflective signal to the processing module; and
processing, by the processing module, the high frequency reflective signal and the low frequency reflective signal into image signals.

10. The signal processing method of claim 9, wherein the step of the processing module processing the high frequency reflective signal and the low frequency reflective signal into the image signals includes:
receiving, by a plurality of multiplexers, the high frequency reflective signal and the low frequency reflective signal;
converting the high frequency reflective signal and the low frequency reflective signal outputted by the plurality of multiplexers into a high frequency reflective digital signal and a low frequency reflective digital signal; and
respectively processing the high frequency reflective digital signal and the low frequency reflective digital signal into a first image and a second image.

11. The signal processing method of claim 9, wherein a bandwidth of the first signal covers bandwidths of the high frequency reflective signal and the low frequency reflective signal.

12. The signal processing method of claim 9, wherein the first probing device is a phase array probe and the second probing device is a curved linear array probe. 13 . The signal processing method of claim 11, wherein the first probing device and the second probing device are formed on a piezoelectric material, and a thickness of the first probing device and the second probing device are different.

14. A probing module, comprising:
a transmitting device, configured to transmit a first signal;
a first probing device, configured to receive a high frequency reflective signal corresponding to the first signal; and
a second probing device, coupled to the first probing device, configured to receive a low frequency reflective signal corresponding to the first signal;
wherein the high frequency reflective signal and the low frequency reflective signal are processed into image signals.

15. The probing module of claim 14, wherein the probing module is mounted on a ship hull, the first probing device is mounted towards a bottom of the ship hull to receive the high frequency reflective signal, and the second probing device is mounted towards a front of the ship hull to receive the low frequency reflective signal.

16. The probing module of claim 15, wherein the first probing device includes a plurality of first probing elements, the second probing device includes a plurality of probing elements, wherein the plurality of first probing elements and the plurality of second probing elements are arranged in series, the plurality of first probing elements are arranged in a straight line and the plurality of second probing elements are arranged in a curved line.
